(19) United States
(12) Patent Application Publication
(10) Pub. No.: US 2012/0231850 A1
(43) Pub. Date: Sep. 13, 2012

(54) DEVICE AND METHOD FOR SELECTIVE CONVEYANCE OF A SOUND

(75) Inventors: Michael Wayne SHORE, Dallas, TX (US); Norma DICKEY, Dallas, TX (US)

(73) Assignee: SOUTHTOUCH PARTNERS, LLC, Dallas, TX (US)

(21) Appl. No.: 13/399,772

(22) Filed: Feb. 17, 2012

Related U.S. Application Data
(60) Provisional application No. 61/450,415, filed on Mar. 8, 2011.

(51) Int. Cl. H04W 68/00; H04W 88/02

(52) U.S. Cl. 455/566

(57) ABSTRACT

An application program stored on a mobile telephone is provided. The mobile telephone has a controller and the application program is configured to be executed by the controller. Upon execution of the application program, the controller displays an activation area on a display screen of the mobile telephone. The activation area has at least a first portion and a second portion distinct from the first portion. Upon selection of the first portion of the activation area, the controller accesses one or more prerecorded sounds stored in a memory of the mobile telephone or stored remotely. The controller then displays a listing of identification values associated with the one or more stored prerecorded sounds, retrieves at least one sound upon selection thereof by a user, and transmits the at least one selected sound.

### CROSS-REFERENCE TO RELATED APPLICATION

This application claims the benefit of U.S. Provisional Patent Application No. 61/450,415, filed on Mar. 8, 2011, entitled “Device and Method for Selective Conveyance of a Sound,” the entire contents of which are incorporated by reference herein.

### BACKGROUND OF THE INVENTION

An embodiment of the present invention relates generally to an application for selectively conveying a customized tone during a telephone call and, more particularly, to an application that can be downloaded to a mobile telephone device and is configured to allow a user to select and transmit a particular tone or sound during a telephone call.

In recent years, it has become more and more commonplace to have a telephone conversation with another party using a cellular or mobile telephone, such as a smart phone. Often during such telephone conversations, one party may experience various types of emotions—love, hate, anger, frustration and the like—toward the other party to the telephone conversation. Unfortunately, words alone cannot always effectively express the user's emotions. Particular sounds or tones, however, can often prove very helpful and effective in expressing a large range of emotions.

Therefore, it would be desirable to provide a device or application which provides a mobile phone user with a selection of tones or sounds that can be transmitted to the other party to the telephone call upon the user's command.

### BRIEF SUMMARY OF THE INVENTION

Briefly stated, one embodiment of the present invention is directed to an application program stored on a mobile telephone having a controller. The application program is configured to be executed by the controller. Upon execution of the application program, the controller displays an activation area on a display screen of the mobile telephone. The activation area has at least a first portion and a second portion distinct from the first portion. Upon selection of the first portion of the activation area, the controller accesses one or more prerecorded sounds stored in a memory of the mobile telephone or stored remotely. The controller then displays a listing of identification values associated with the one or more stored prerecorded sounds, retrieves at least one sound upon selection thereof by a user, and transmits the at least one selected sound.

Another embodiment of the present invention is directed to mobile telephone. The mobile telephone has a display screen, a memory and a controller. The memory is configured to store an application program, and the controller is configured to access and execute the application program. Execution of the application program causes the controller to retrieve and transmit one or more sounds during a telephone call.

Another embodiment of the present invention is directed to a method of selectively transmitting a prerecorded sound on a mobile telephone. The mobile telephone has a display, a memory and a controller. The mobile telephone is also provided with an application program. The controller of the mobile telephone is configured to execute the application program and cause an activation area to be displayed on the display screen. One or more prerecorded sounds are stored in the memory of the mobile telephone. Each stored sound is associated with a corresponding identification value. The identification values of the one or more stored sounds are displayed on the display of the mobile telephone. The one or more sounds are retrieved from the memory of the mobile telephone, and the one or more retrieved sounds are then transmitted by the mobile telephone.

### BRIEF DESCRIPTION OF THE DRAWINGS

The foregoing summary, as well as the following detailed description of preferred embodiments of the present invention, will be better understood when read in conjunction with the appended drawings. For the purpose of illustration, there is shown in the drawings embodiments which are presently preferred. It should be understood, however, that the device and method are not limited to the precise arrangements and instrumentalities shown.

In the drawings:

FIG. 1 is a front perspective view of a mobile telephone in accordance with a preferred embodiment of the present invention; and

FIG. 2 is a flow diagram of a method of using the mobile telephone in accordance with a preferred embodiment of the present invention.

### DETAILED DESCRIPTION OF THE INVENTION

Certain terminology is used in the following description for convenience only and is not limiting. The words “right,” “left” and “top” designate directions in the drawings to which reference is made. Additionally, the terms “a,” “an” and “the,” as used in the specification, mean “at least one.” The terminology includes the words above specifically mentioned, derivatives thereof, and words of similar import.

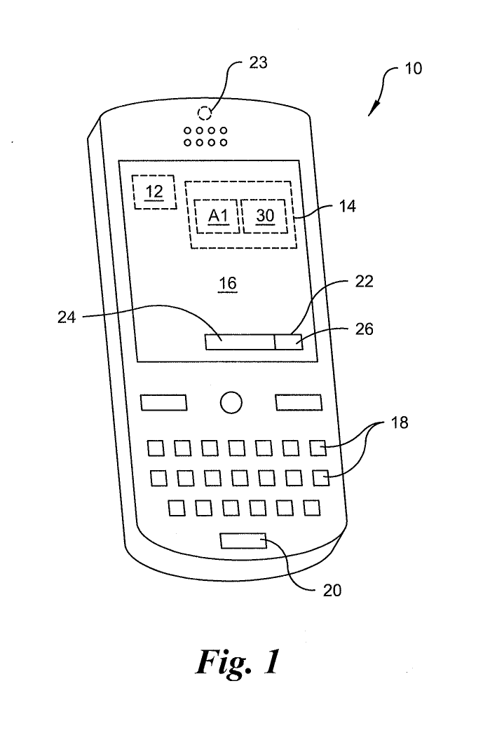

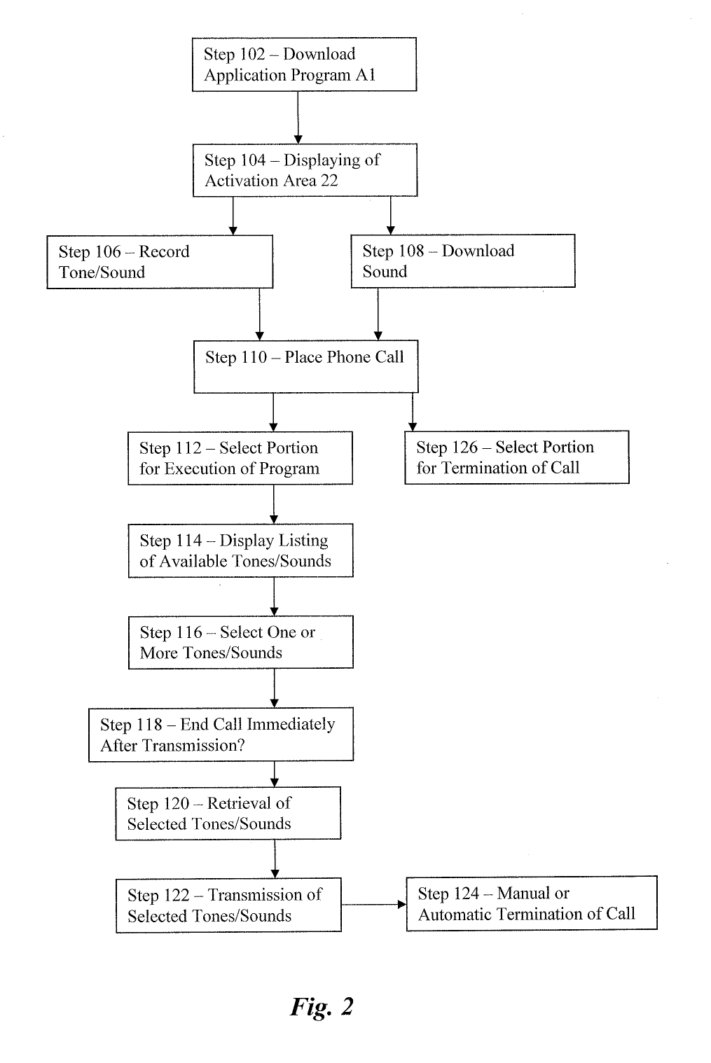

Referring to the drawings and detail, wherein like numerals indicate like elements throughout, FIGS. 1-2 show a preferred embodiment of a mobile telephone, generally designated 10 (FIG. 1), and a preferred embodiment of a method of using the mobile telephone 10 for selecting and transmitting one or more of a plurality of available pre-recorded tones 30 during a telephone call. One skilled in the art will understand that the tones 30 may include a variety of types of sounds and messages. Each of the tones 30 is preferably associated with an identification value. Examples of identification values include an identifying title or name, a graphical representative image, an icon and the like.

Preferably, the mobile telephone 10 displays a plurality of identification values to the mobile telephone user and the mobile telephone user then selects an identification value to be assigned to each of the tones 30. In another embodiment, each of the tones 30 is assigned a default identification value, which the mobile telephone user may then choose to change or to leave unchanged. In yet another embodiment, the user of the mobile telephone 10 can create customized identification values for one or more tones 30.

The tones 30 may have pleasant or unpleasant connotations, such that a user will be able to transmit a tone 30 that effectively conveys the user's feelings, thoughts or emotions. For example, a tone 30 that resembles the sound of a door slamming would effectively reflect the user's anger. A tone 30 that resembles the sound of an offensive bodily noise might be effective in reflecting a user's annoyance or irritation. A tone 30 that resembles the sound of a kiss between two people might be effective in reflecting pleasant emotions, such as love.

The mobile telephone 10 may be any generally mobile device that is capable of functioning as a personal information manager and is capable of communicating with another device. Preferably, the mobile telephone 10 is capable of connecting wirelessly to an electronic network, such as the Internet. The mobile telephone 10 preferably contains hardware that can support an Internet or network connection using a wireless protocol. Examples of the mobile telephone 10 include a cellular telephone, an IPHONE, an IPAD, a PALM PILOT, a BLACKBERRY, a DROID, an HTC, a personal digital assistant (PDA) or any other smart phone or the like.

Referring to FIG. 1, the mobile telephone 10 includes a controller 12 and a memory 14. The memory 14 can be any known or suitable memory device or combination of such devices, such as random access memory (RAM), read only memory (ROM), flash RAM, hard disk, optical disk, or the like. The mobile telephone 10 further includes a video display screen or monitor 16 that is operatively connected to the controller 12. Preferably, the video display screen 16 is a touchscreen video display configured to accept touch input. The mobile telephone 10 also optionally includes other input devices, such as a trackball, a touchpad, a track stick, arrow keys, or a keypad or keyboard 18. The mobile telephone 10 also preferably includes a microphone or other type of audio input 20 and a speaker or other type of audio output 23, each of which is coupled to the controller 12.

In one embodiment, a user may record one or more customized tones 30 directly on the device 10 using the audio input 20. In another embodiment, one or more prerecorded tones 30 may be downloaded, preferably wirelessly, from the Internet and/or from a catalog of tones 30 stored at a central server. Preferably, the mobile telephone user may combine or string together different tones 30 to create a new customized tone 30. The memory 14 of the mobile telephone 10 is configured to store a plurality of customized and/or prerecorded tones 30 or sounds. One or more of the tones 30 may also be stored remotely, such as at a central server or other remote file storage locations (not shown) accessible by the controller 12. The controller 12 of the mobile telephone 10 preferably communicates with any such server or remote locations over a wireless transceiver (not shown). In another embodiment, one or more tones 30 may be included in the conventional software for the mobile telephone 10.

In one embodiment, tones 30 that have one or more characteristics in common may also be grouped together into a category 40. Preferably, a plurality of the categories 40 is stored in the memory 14 of the mobile telephone 10 or at a remote server or file storage location (not shown). For example, different tones 30, each of which conveys a common emotion, such anger or happiness, may be assigned to a single category 40 representative of that common emotion. Each category 40 is also preferably associated with a categorical identification value, such as an identifying title or name, a graphical image, an icon and the like, which is representative of the associated category 40 of the plurality of different tones 30.

Preferably, the mobile telephone user creates each of the categories 40 and assigns one or more tones 30 to a particular category 40. In another embodiment, a plurality of default categories 40 may be pre-stored in the memory 14 of the mobile telephone 10 with one or more tones 30 assigned to a default category 40. The mobile telephone user may choose to either leave each tone 30 in the default category 40 or to assign one or more tone 30 to another category 40.

Preferably, the mobile telephone 10 displays a plurality of category identification values to the mobile telephone user and the mobile telephone user then selects a category identification value to be assigned to each of the categories 40. In another embodiment, each of the categories 40 is assigned a default category identification value, which the mobile telephone user may then choose to change or to leave unchanged. In yet another embodiment, the user of the mobile telephone 10 can create customized category identification values for one or more of the categories 40.

Along with the plurality of customized and/or prerecorded tones 30, the memory 14 is also preferably configured to store one or more application programs downloaded, preferably wirelessly, from the Internet. The controller 12 of the mobile telephone 10 is preferably configured to access and execute the one or more downloaded application programs from the memory 14. Preferably, the mobile telephone 10, and more particularly, the memory 14 of the mobile telephone 10, includes an application program A1 that that has been downloaded from the Internet or over a wireless cellular connection. In another embodiment, the application program A1 has been previously installed and/or factory installed on the mobile telephone 10.

The application program A1 is configured to be executed by the controller 12 of the mobile telephone 10. Preferably, the application program A1 is automatically executed by the controller 12 each time a telephone call commences. Alternatively, the application program A1 is executed only upon a manual command provided by the user of the mobile telephone 10.

Upon execution of the program A1, the controller 12 is configured to access the available customized and/or prerecorded tones 30 stored in the memory 14 or stored remotely, and generally simultaneously present an array or listing of the available tones 30 or an array or listing of the available categories 40 of tones 30 to the user of the mobile telephone 10. Preferably, the controller 12 causes the display screen 16 to display a listing of the identification values of all or some of the tones 30 available for transmission or a listing of the category identification values of all or some of the categories 40 of available tones 30. Preferably, the display screen 16 presents an alphabetical listing of one or more of the identification values for each of the available tones 30 or categories 40.

In one embodiment, where the application program A1 causes the controller 12 to display the identification values of all or some of the tones 30 available for transmission, the mobile telephone user may then select one or more tones 30 from the plurality of available tones 30 by selecting the associated identification value(s), and the controller 12 then retrieves the selected tone(s) 30 and causes the selected tone(s) 30 to be played and/or transmitted. Accordingly, once the application program A1 is downloaded to the mobile telephone 10, the mobile telephone 10 becomes equipped to selectively play and/or transmit a customized or prerecorded tone 30. The transmitted tone 30 is also audible to the mobile telephone user.

In another embodiment, where the application program A1 causes the controller 12 to display the category identification values of all or some of the categories 40 of tones 30 available for transmission, the mobile telephone user may then select a category 40 representative of the desired emotion (e.g., anger, love, happiness, and the like). The controller 12 then causes the display screen 16 to display the identification values of all or some of the tones 30 assigned to that category 40 and available for transmission. Each of these tones 30 will in some way convey the desired emotion (e.g., anger, love, happiness, and the like) of the selected category 40, but will sound at least slightly different from each other. The mobile telephone user may then select one or more tones 30 from the selected category 40 by selecting the associated identification value(s) of the tone(s) 30. The controller 12 then retrieves the selected tone(s) 30 and causes the selected tone(s) 30 to be played and/or transmitted to the other party or parties to the telephone call.

In one embodiment, the controller 12 accesses, retrieves and plays the selected tone(s) 30 directly from the memory 14 of the mobile telephone 10. In another embodiment, the controller 12 accesses and retrieves the selected tone(s) 30 from a remote location and the selected tone(s) 30 are streamed to the controller 12 via a Broadband connection or the like.

In one embodiment, upon selection of a tone 30, the application program A1 causes the controller 12 to send a text message to the other party or parties to the telephone call, and the selected tone 30 is played upon the other party or parties accessing or opening up the text message. In another embodiment, upon selection of a tone 30, the application program A1 causes the controller 12 to send an electronic mail message to the other party or parties to the telephone call, and the selected tone 30 is played upon the other party or parties accessing or opening up the electronic mail message.

In one embodiment, once the application program A1 is downloaded to the mobile telephone 10, the controller 12 preferably causes an activation area 22 to be displayed on the display screen 16, which is preferably a touchscreen 16. In one embodiment, the activation area 22 is preferably a software button, key, selector, marker and the like. The activation area 22 may appear on the display screen 16 at all times or only at select times during which the mobile telephone 10 is being used for a telephone call. Alternatively, the mobile telephone 10 may already be equipped with an activation area 22. The activation area 22 may appear on the main or default screen of the mobile telephone 10, so that a user can easily transmit a tone 30 when desired. Alternatively, the activation area 22 may appear on a separate screen, such as a sound screen, as described in more detail below.

The activation area 22 preferably includes a plurality of portions and, more preferably, at least a first portion 24 and a second portion 26. More preferably, each of the first and second portions 24, 26 of the activation area 22 is provided with a different identifier so the first and second portions 24, 26 are clearly distinguishable from each other. For example, the first portion 24 may be of a first color, while the second portion 26 is of a second, different color. Depression or selection of the first portion 24 of the activation area 22 triggers the controller 12 to access and present to the user the listing of customized and/or prerecorded tones 30 available for transmission. The user is then prompted by the application program A1 to select one or more tones 30 for transmission. The user may then select one or more tones 30, and choose to have the selected tone(s) 30 transmitted instantly upon selection or just prior to termination of the telephone call. Preferably, the controller 12 causes the telephone call to be automatically terminated upon transmission of the selected tone(s) 30.

Depression or selection of the second portion 26 of the activation area 22 triggers the controller 12 to terminate the telephone call without transmission of a tone 30. Thus, selection of the second portion 26 effectively temporarily disables the application program A1. It will be understood by those skilled in the art that while the first portion 24 is described as being associated with execution of the application program A1 and the second portion 26 is described as being associated with termination of a telephone call without transmission of a sound, the opposite meanings may be associated with each of the first and second portions 24, 26.

In one embodiment, the mobile telephone 10 is programmed to include a “sounds screen” as one of the menu options on the device 10. The “sounds screen” will display the above-described listing of the tones/sounds 30 available for transmission. When the mobile telephone 10 is a smart phone which enables the user to switch screens during a telephone call, the user may navigate to the “sounds screen” during the call and browse through the available tones/sounds 30 during the call. Thus, a selected tone 30 may be transmitted to the other party and interjected into the telephone call as desired by the user of the mobile telephone 10.

The “sounds screen” is preferably equipped with the above-described activation area 22, such that the user may choose among various options for after transmission of the selected tone 30. For example, the user may choose for the telephone call to be automatically terminated immediately upon transmission of the tone 30 or after a predetermined duration has elapsed, or the user may choose to have the telephone call continue until it is manually terminated by one of the parties after transmission of the selected tone 30.

In one embodiment, the mobile telephone 10 may be programmed to store one or more settings. For example, the mobile telephone 10 and, more particularly, the controller 12 may be programmed to transmit a default tone 30, as selected by the mobile telephone user, upon or just prior to termination of every telephone call, without requiring the user to manually select a tone 30. In another embodiment, the controller 12 may be programmed to transmit a particular tone 30 to a particular individual automatically upon or just prior to termination of a telephone call with that individual. More particularly, the mobile telephone 10 may be equipped with a setting that ensures that the same tone 30 is transmitted to one particular individual automatically upon or just prior to termination of every telephone call with that individual. For example, a user may include a preset setting on his mobile telephone 10 so that a prerecord tone 30 of a kiss is automatically transmitted during a telephone call with the user's significant other.

The method of using the mobile telephone 10 of the present invention preferably includes the steps illustrated in the flow diagram of FIG. 2. For example, as part of initial set-up process, the user of the mobile telephone 10 downloads the application program A1 to the mobile telephone 10 (Step 102). Step 102 may be eliminated if the application program A1 was previously stored or factory installed on the mobile telephone 10. Next, the controller 12 executes the application program A1 and causes the activation area 22 associated with the downloaded application program A1 to be displayed on the video display 16 (Step 104). The application program A1 may be automatically executed upon downloading of the application program A1, such that the activation area 22 is displayed at all times, or may only be executed at times during which the mobile telephone 10 is being used for a telephone call. In the latter configuration, the application program A1 may automatically be executed by the controller 12 upon commencement of a telephone call or upon a command input provided by the user.

Once the application program A1 has been stored on the mobile telephone 10, the user may record one or more customized tones 30 and the tones 30 are stored in the memory 14 (Step 106). Step 106 may also be performed prior to or together with Step 102. Alternatively, or in addition to Step 106, the user may download one or more tones 30 from the Internet or over a wireless cellular network, or from a catalog of tones 30 stored at a central server (Step 108). Alternatively, or in addition to Steps 106 and 108, the mobile telephone 10 may come equipped with one or more tones 30 stored in the memory 14. It will be understood by those skilled in the art that Steps 106 and 108 may be avoided altogether, since the application program A1 also allows for remotely stored tones 30 to be selected for play and streamed at a desired time.

The user may then place a telephone call at any desired time (Step 110). At any point during the telephone call, such as in the middle of the telephone call or closer to when the call will be terminated, the user may touch or select the first portion 24 of the activation area 22 (Step 112). This prompts the controller 12 to access the memory 14 or the remote storage locations (not shown), and cause the video display screen 16 to display a listing of the identification values for all or some of the tones 30 available for selection and transmission (Step 114). The user is then prompted to select one or more tones 30 for transmission (Step 116). The user may also optionally specify that the call is to be terminated generally immediately after or simultaneously with transmission of the selected tone(s) 30 (Step 118).

The controller 12 then retrieves the selected tone(s) 30 either directly from the memory 14 or from the remote storage location (not shown), and the selected tone(s) 30 are transmitted to the other party to the telephone call (Step 120). Upon transmission of the selected tone(s) 30, the telephone call with either continue until one party manually terminates the call or the controller 12 will automatically terminate the call (Steps 122 and 124). Alternatively, after Step 110, the user may touch or select the second portion 26 of the activation area 22 to terminate the telephone call without the transmission of a tone 30 (Step 126).

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. An application program stored on a mobile telephone having a controller, the application program being configured to be executed by the controller and, upon execution, causing the controller to perform steps comprising:
(i) displaying an activation area on a display screen of the mobile telephone, the activation area including at least a first portion and a second portion distinct from the first portion;
(ii) accessing, upon selection of the first portion of the activation area, one or more prerecorded sounds stored in a memory of the mobile telephone or stored remotely;
(iii) displaying a listing of identification values associated with the one or more stored prerecorded sounds;
(iv) retrieving at least one sound upon selection thereof by a user; and
(v) transmitting the at least one selected sound.

2. The application program according to claim 1, wherein the at least one sound is transmitted upon or just prior to termination of a telephone call.

3. The application program according to claim 2, wherein the telephone call is terminated immediately upon transmission of the at least one sound.

4. The application program according to claim 2, wherein the telephone call is terminated after a predetermined time has elapsed after transmission of the at least one sound.

5. The application program according to claim 1, wherein the at least one sound is transmitted immediately upon selection of the sound.

6. The application program according to claim 1, wherein selection of the second portion of the activation area causes the mobile telephone to terminate a telephone call without transmission of a sound.

7. The application program according to claim 1, wherein the application program is executed automatically upon commencement of a telephone call.

8. The application program according to claim 1, wherein the identification values are at least one of a title, name, graphic, and icon.

9. A mobile telephone comprising:
a display screen;
a memory configured to store an application program; and
a controller configured to access and execute the application program, execution of the application program causing the controller to (i) retrieve and transmit one or more sounds during a telephone call; and (ii) display an activation area on the display screen, the activation area including a first portion and a distinct second portion.

10. The mobile telephone according to claim 9, wherein the display screen is a touchscreen.

11. The mobile telephone according to claim 9 further comprising an input device, the input device being one of a trackball, a touchpad, a track stick, and arrow keys.

12. The mobile telephone according to claim 9, wherein the controller is configured to:
(i) upon selection of the first portion of the activation area, access the one or more sounds and displays a listing of identification values associated with the one or more sounds; and
(ii) upon selection of the second portion of the activation area, terminate the telephone call without transmission of the one or more sounds.

13. The mobile telephone according to claim 9 further comprises an audio input, the controller being configured to record a sound received via the audio input and store the recorded sound in the memory of the mobile telephone.

14. The mobile telephone according to claim 9, wherein the one or more sounds are retrieved from either of the memory of the telephone or a remote server.

15. The mobile telephone according to claim 9, where the telephone call is terminated immediately upon transmission of the one or more sounds.

16. A method of selectively transmitting a prerecorded sound on a mobile telephone including a display, a memory and a controller, the method comprising:
(i) providing the mobile telephone with an application program, the controller of the mobile telephone being configured to execute the application program and cause an activation area to be displayed on the display screen;
(ii) storing one or more prerecorded sounds in the memory of the mobile telephone, each stored sound being associated with a corresponding identification value;
(iii) causing the identification values of the one or more stored sounds to be displayed on the display of the mobile telephone;
(iv) causing the one or more sounds to be retrieved from the memory of the mobile telephone; and
(v) causing the one or more retrieved sounds to be transmitted by the mobile telephone.

17. The method according to claim 16, wherein the one or more sounds are transmitted during a telephone call.

18. The method according to claim 17, further comprising causing the telephone call to be automatically terminated upon transmission of the one or more sounds.
